(19) United States
(12) Patent Application Publication
(10) Pub. No.: US 2025/0131389 A1
(43) Pub. Date: Apr. 24, 2025

(54) APPARATUSES, SYSTEMS, AND METHODS FOR PROVIDING A CUSTOMIZABLE AND INTERACTIVE TASK MANAGEMENT PLATFORM

(71) Applicant: Thumbtack, Inc., San Francisco, CA (US)

(72) Inventors: Anaïs Ziae-Mohseni, Alhambra, CA (US); Kelsey Dunn, Brooklyn, NY (US); Melissa Hribar, Brooklyn, NY (US); Daniel Capo, Tuckahoe, NY (US); Gerrit Feenstra, Phoenix, AZ (US); Yin Li, Oakland, CA (US)

(21) Appl. No.: 18/924,468

(22) Filed: Oct. 23, 2024

Related U.S. Application Data
(60) Provisional application No. 63/545,320, filed on Oct. 23, 2023.

(51) Int. Cl. G06Q 10/1093; G06F 3/0482; G06F 9/451; G06F 16/9035

(52) U.S. Cl. CPC G06Q 10/1097; G06F 3/0482; G06F 9/451; G06F 16/9035

(57) ABSTRACT

Various implementations disclosed herein include methods and systems for recommending particular tasks and/or guides relating to user property. The methods and systems disclosed herein personalize recommended tasks into a plan to guide users in maintenance and care of the user property. Additionally, the methods and systems generate and present guides in association with recommended tasks and/or the personalized plan to improve understanding and streamline a user-professional matching platform.

### CROSS REFERENCE TO RELATED APPLICATIONS

This patent claims the benefit of U.S. Provisional Application No. 63/545,320 entitled “Apparatuses, Systems, And Methods For Providing A Customizable And Interactive Task Management Platform” and filed Oct. 23, 2023. U.S. Provisional Application No. 63/545,320 is hereby incorporated by reference herein in its entirety.

### TECHNICAL FIELD

The present disclosure generally relates to apparatuses, systems, and methods for providing a customizable and interactive task management platform.

### BACKGROUND

Various techniques are used to provide task management platforms. In some examples, users are provided the option to create a task that is added to a task list. However, the user may be required to manage progress and/or completion of such an added task. In some examples, the tasks available to a user are generic. Often many such tasks are irrelevant to a particular user.

### SUMMARY

Various implementations disclosed herein include a customizable and interactive task management platform that may enable a user to create and track relevant tasks throughout completion. In some examples, details about a user or a user's environment may be obtained to generate individualized recommended tasks. In some such examples, users may become informed of required tasks that would otherwise go unnoticed or unacknowledged. In some examples, detailed guidance regarding such tasks may be made available to a user in order to better understand particular tasks, associated subtasks, timelines and frequencies associated with tasks or subtasks, and steps required for competition of such tasks or subtasks. In some examples, the detailed guidance may be directly associated with a particular task. In some examples, the detailed guidance may be a discrete component separate from a particular task.

An example method comprises determining an aspect of a user profile, accessing a first database comprising a plurality of tasks, accessing a second database comprising a plurality of guides, comparing the aspect of the user profile to one or more aspects of the plurality of tasks, determining, based on the comparing, one or more tasks of the plurality of tasks that correspond with the aspect of the user profile, determining one or more guides of the plurality of guides that correspond with the determined one or more task, and presenting the one or more tasks or the one or more guides.

Another example method comprises determining an aspect of a user profile, accessing a first database comprising a plurality of tasks, accessing a second database comprising a plurality of guides, comparing the aspect of the user profile to one or more aspects of the plurality of guides, determining, based on the comparing, one or more guides of the plurality of guides that correspond with the aspect of the user profile, determining one or more tasks of the plurality of tasks that correspond with the determined one or more guides, and presenting the one or more tasks or the one or more guides.

Another example method comprises determining an aspect of a user profile, accessing a first database comprising a plurality of tasks, accessing a second database comprising a plurality of guides, comparing the aspect of the user profile to one or more first aspects of the plurality of tasks, determining, based on the comparing the aspect of the user profile to one or more first aspects of the plurality of tasks, one or more tasks of the plurality of tasks that correspond with the aspect of the user profile, comparing the aspect of the user profile to one or more second aspects of the plurality of guides, determining, based on the comparing the aspect of the user profile to one or more second aspects of the plurality of guides, one or more guides of the plurality of guides that correspond with the aspect of the user profile, presenting a first user interface recommending at least one of the one or more tasks or the one or more guides; receiving user selection of at least one of the one or more tasks, presenting a second user interface comprising the at least one of the one or more tasks, receiving user selection of at least one of the one or more guides, and presenting a third user interface comprising the at least one of the one or more guides.

An example system comprises one or more processors and memory storing instructions that, when executed by the one or more processors, cause the system to determine an aspect of a user profile, access a first database comprising a plurality of tasks, access a second database comprising a plurality of guides, compare the aspect of the user profile to one or more aspects of the plurality of tasks, determine, based on the comparison, one or more tasks of the plurality of tasks that correspond with the aspect of the user profile, determine one or more guides of the plurality of guides that correspond with the determined one or more task, and present the one or more tasks or the one or more guides.

Another example system comprises one or more processors and memory storing instructions that, when executed by the one or more processors, cause the system to determine an aspect of a user profile, access a first database comprising a plurality of tasks, access a second database comprising a plurality of guides, compare the aspect of the user profile to one or more aspects of the plurality of guides, determine, based on the comparison, one or more guides of the plurality of guides that correspond with the aspect of the user profile, determine one or more tasks of the plurality of tasks that correspond with the determined one or more guides, and present the one or more tasks or the one or more guides.

Another example system comprises one or more processors and memory storing instructions that, when executed by the one or more processors, cause the system to determine an aspect of a user profile, access a first database comprising a plurality of tasks, access a second database comprising a plurality of guides, compare the aspect of the user profile to one or more first aspects of the plurality of tasks, determine, based on the comparing the aspect of the user profile to one or more first aspects of the plurality of tasks, one or more tasks of the plurality of tasks that correspond with the aspect of the user profile, compare the aspect of the user profile to one or more second aspects of the plurality of guides, determine, based on the comparison of the aspect of the user profile to one or more second aspects of the plurality of guides, one or more guides of the plurality of guides that correspond with the aspect of the user profile, present a first user interface recommending at least one of the one or more tasks or the one or more guides; receive user selection of at least one of the one or more tasks, present a second user interface comprising the at least one of the one or more tasks, receive user selection of at least one of the one or more guides, and present a third user interface comprising the at least one of the one or more guides.

An example non-transitory computer readable storage medium stores instructions that, when executed, may cause performance of determining an aspect of a user profile, accessing a first database comprising a plurality of tasks, accessing a second database comprising a plurality of guides, comparing the aspect of the user profile to one or more aspects of the plurality of tasks, determining, based on the comparing, one or more tasks of the plurality of tasks that correspond with the aspect of the user profile, determining one or more guides of the plurality of guides that correspond with the determined one or more task, and presenting the one or more tasks or the one or more guides.

Another example non-transitory computer readable storage medium stores instructions that, when executed, may cause performance of determining an aspect of a user profile, accessing a first database comprising a plurality of tasks, accessing a second database comprising a plurality of guides, comparing the aspect of the user profile to one or more aspects of the plurality of guides, determining, based on the comparing, one or more guides of the plurality of guides that correspond with the aspect of the user profile, determining one or more tasks of the plurality of tasks that correspond with the determined one or more guides, and presenting the one or more tasks or the one or more guides.

Another example non-transitory computer readable storage medium stores instructions that, when executed, may cause performance of determining an aspect of a user profile, accessing a first database comprising a plurality of tasks, accessing a second database comprising a plurality of guides, comparing the aspect of the user profile to one or more first aspects of the plurality of tasks, determining, based on the comparing the aspect of the user profile to one or more first aspects of the plurality of tasks, one or more tasks of the plurality of tasks that correspond with the aspect of the user profile, comparing the aspect of the user profile to one or more second aspects of the plurality of guides, determining, based on the comparing the aspect of the user profile to one or more second aspects of the plurality of guides, one or more guides of the plurality of guides that correspond with the aspect of the user profile, presenting a first user interface recommending at least one of the one or more tasks or the one or more guides; receiving user selection of at least one of the one or more tasks, presenting a second user interface comprising the at least one of the one or more tasks, receiving user selection of at least one of the one or more guides, and presenting a third user interface comprising the at least one of the one or more guides.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates a block diagram of a task management system in accordance with the examples disclosed herein.

FIGS. 2-12 illustrate block diagrams of example user interfaces in accordance with the examples disclosed herein.

FIG. 13 illustrates a flowchart representative of a method for recommending tasks and guides in accordance with the examples disclosed herein.

FIG. 14 illustrates a block diagram of example structural components in accordance with the examples disclosed herein.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

The present disclosure describes a customizable and interactive task management platform that may enable a user to create and track relevant tasks throughout completion. As a non-limiting example, the customizable and interactive task management platform may relate to the various tasks and maintenance of a user's home and/or personal property. As users' homes/property may vary in terms of location, size, configuration, needs, etc., so do the various tasks or maintenance associated therewith. As such, generic task lists likely provide many irrelevant tasks to a particular user. For example, people living in an apartment may be uninterested in gutter cleaning relating tasks. Likewise, people without a pool may be uninterested in pool cleaning related tasks. In some examples, people with a pool may be uninterested in pool cleaning related tasks based on the time of year (e.g., there may be no need to clean a pool in the wintertime in Chicago).

In some examples, people may be uneducated in particular required tasks associated with the user's home/property. For example, a new homeowner may be unaware that an inground sprinkler system requires its valves removed and the lines emptied prior to the outside temperatures dropping below freezing. Likewise, a new homeowner may be unaware of the risks associated with radon leaking into their basement. Accordingly, in some examples, generic task lists may include tasks that are relevant to a user, but the user may not be aware of the task's relevance.

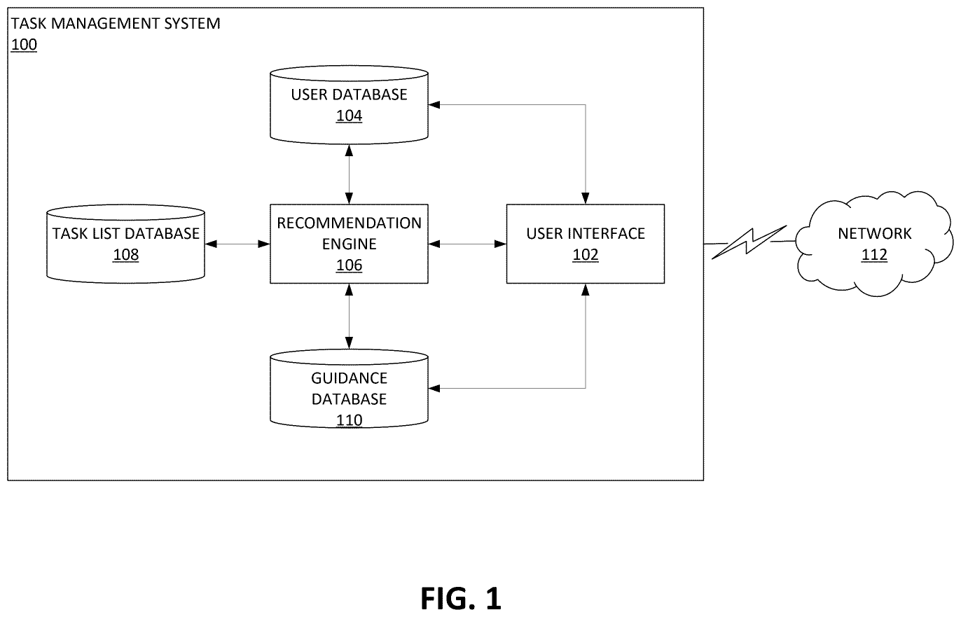

In order to provide users with relevant tasks, a task management system 100 is provided, as illustrated in FIG. 1. The task management system 100 may comprise a user interface 102, a user database 104, a recommendation engine 106, a task list database 108, and a guidance database 110. In some examples, the task management system 100 may further be connected to a network 112 such as, for example, the Internet. The example user interface 102 may enable interaction with users to obtain information from and present information to users. Information obtained from a user may be stored in the user database 104. In some examples, the user database 104 stores profile information about a user and/or their property. For example, the user database 104 may store user-specific information such as name, age, occupation, level of education, marital status, property goals, etc. The user database 104 may also store property-specific information such as location, climate, property type, number of bedrooms, number of bathrooms, number of floors, the presence or absence of various features (e.g., lawn, pool, septic, water conditioner/softener, sprinkler system, basement, etc.) associated with a property, etc. In some examples, the user-specific information and the property-specific information may be stored together as a user profile. In some examples, the user profile is updated over time to include updated information and/or activity data from the task management system 100 and/or information and/or activity data from other connected accounts (e.g., social media, real estate, etc.).

In some examples, the user database 104 may access third-party information relating to a user or their property through one or more application programming interfaces (APIs). For example, the user database 104 may access social media websites (e.g., Facebook®, LinkedIn®) associated or created by a user. The user database 104 may access real estate websites (e.g., Zillow®, MLS®, county property assessor, etc.) associated with a user's property. In some examples, the user database 104 may utilize image recognition software to determine aspects of a user's home/property based on top-down satellite images, street-view images, photographs, video, augmented reality, or 3D reconstructions of a user's home/property. In some examples, a recently performed home inspection report may be accessed, analyzed, and the details therein stored in accordance with the user profile. In some such examples, the home inspection report may enable the recommendation engine 106 to prioritize tasks that may otherwise be deprioritized or be labeled a long-term goal (e.g., roof replacement, electrical rewiring, HVAC upgrades, etc.). In some such examples, specific details about a property that may otherwise be unknown may be determined based on analysis of such third-party information (e.g., brands of appliances, type of water heater (tankless v. tank), number of furnaces/air conditioning units, existence of skylights, number of trees, etc.). In some examples, a user may, via the user interface 102, upload a copy of a recent home inspection report directly to the task management system 100 for storage in the user database 104 so that the recommendation engine 106 may analyze and determine details about the user's property from the user's upload, rather than accessing the home inspection report from a third party. In some examples, the recommendation engine 106 may acquire third-party data from the Internet using web-crawlers.

The example recommendation engine 106 may access a user profile to provide individualized recommendations of tasks, the frequencies associated therewith, and guidance relating to such tasks. In some examples, the example recommendation engine 106 may access the task list database 108 to determine relevant tasks that match with aspects of the user profile (e.g., determine to recommend gutter cleaning to only users whose properties have gutters). In some examples, the recommendation engine 106 may determine to not recommend tasks that match a user's occupation (e.g., determine to not recommend painting tasks to a painter). The task list database 108 may comprise a laundry list of tasks relating to all types of properties, locations, climates and may include various details associated with such tasks such as, for example, cost ranges, whether a particular task is able to be done by a non-professional (e.g., do-it-yourself (“DIY”)), recommended frequencies to perform such a task, etc. Based on the user profile, the example recommendation engine 106 may determine a subset of all such tasks that are relevant to a particular user. In some examples, the recommendation engine 106 may determine a subset of tasks relevant to a particular user at a particular location (e.g., according to climate). In some examples, the recommendation engine 106 may determine a subset of tasks relevant to a particular user at a particular time (e.g., according to season).

Likewise, the example recommendation engine 106 may access the guidance database 110 to determine relevant guides that match with aspects of the user profile (e.g., match guides for boosting curb appeal to users interested in that goal). The guidance database 110 may comprise a laundry list of guides relating to all types of tasks and goals. In some examples, based on the user profile, the example recommendation engine 106 may determine a subset of all such guides that are relevant to a particular user. In some examples, the guides may comprise editorial content describing what is the task(s), why the task(s) is important, repercussions for not performing the task(s), step-by-step instructions for performing the task(s), anticipated returns on investment from performing the task(s), what supplies are need to perform the task(s), estimated costs for performing the task(s) (inclusive of supplies and/or cost to hire a pro), whether the task(s) are DIY friendly, what level of difficulty of performing the task(s), an estimated duration of time for performing the task(s), and/or how to prepare for a professional (“pro”) who is coming to perform the task(s). In some examples, the guidance database 110 and associated relevant guides may be used to instruct and guide a professional (“pro”) to perform tasks (instead of the user) as described, supra with respect to guiding the user to perform the tasks. In some examples, links to purchase relevant task supplies may be included within the guides. In some examples, the guides within the guidance database 110 may be user-created content.

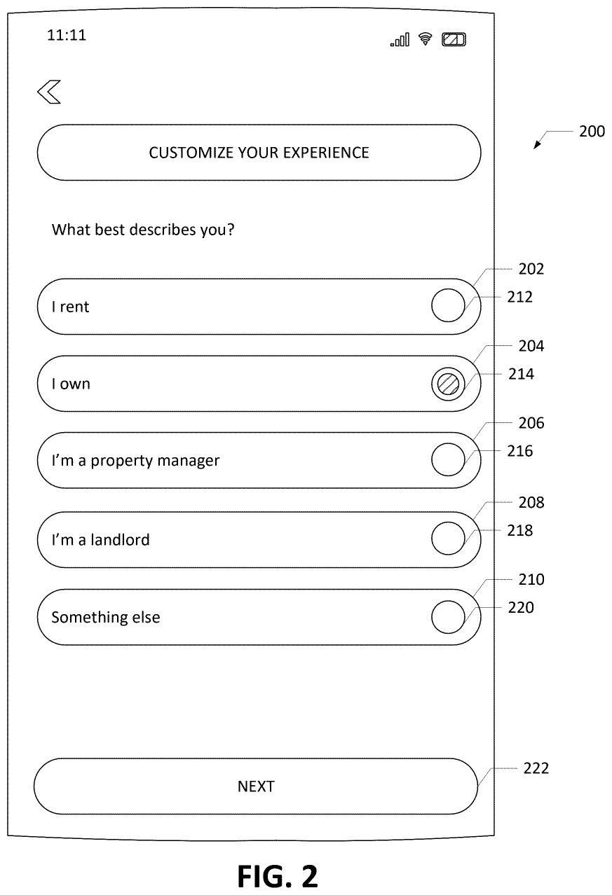

In order to build a user profile, the example user interface 102 may present to a user a series of data input forms as shown in FIGS. 2-6. For example, as shown in FIG. 2, the user interface 102 may present a first form 200 requesting information such as, for example, a description of the user. The description of the user may include, for example, whether the user is a renter, an owner, a property manager, a landlord, something else, etc. In some examples, the first form 200 may include a number of options 202, 204, 206, 208, 210 that may be selected (e.g., with an “X”, a checkmark, a filled shape, etc.) via shapes 212, 214, 216, 218, 220. In some examples, the first form 200 may include an empty text input field for a user to manually enter information, such as, for example text describing the user. Based on the data selected or entered by a user, the first form 200 may enable the user interface 102 to acquire such data and store it in the user database 104 (e.g., a part of a user profile). In some examples, a user may proceed through the series of input forms via a next button 222.

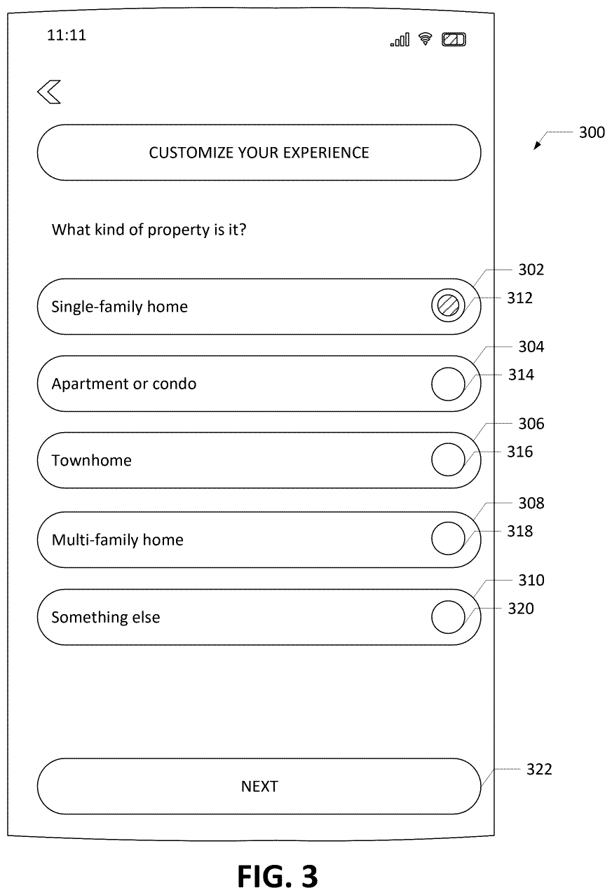

As shown in FIG. 3, the user interface 102 may present a second form 300 (e.g., based on user selection of the next button 222 from the first form 200 of FIG. 2) requesting information such as, for example, a description of a user's property. The description of the user's property may include, for example, whether the user's property is a single-family home, an apartment, a condominium (“condo”), townhouse or townhome, a multi-family home (e.g., a duplex, triplex, flat, etc.), something else, etc. In some examples, the second form 300 may include a number of options 302, 304, 306, 308, 310 that may be selected (e.g., with an “X”, a checkmark, a filled shape, etc.) via shapes 312, 314, 316, 318, 320. In some examples, the second form 300 may include an empty text input field for a user to manually enter information, such as, for example text describing the user's property. Based on the data selected or entered by a user, the second form 300 may enable the user interface 102 to acquire such data and store it in the user database 104 (e.g., a part of a user profile). In some examples, a user may proceed through the series of input forms via a next button 322.

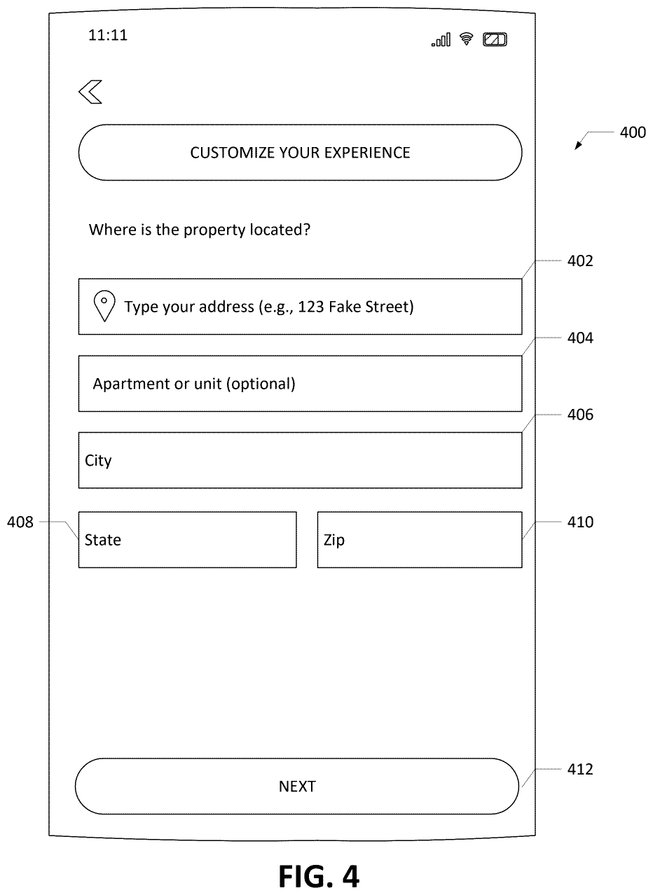

As shown in FIG. 4, the user interface 102 may present a third form 400 (e.g., based on user selection of the next button 322 from the second form 300 of FIG. 3) requesting information such as, for example, a location of a user's property. The location of the user's property may include, for example, a street address, apartment or unit number, city, state, zip code, etc. In some examples, the third form 400 may include a number of text input fields 402, 404, 406, 408, 410 for a user to manually enter information, such as, for example text identifying a street address, apartment or unit number, city, state, and/or zip code. Based on the data selected or entered by a user, the third form 400 may enable the user interface 102 to acquire such data and store it in the user database 104 (e.g., a part of a user profile). In some examples, a user may proceed through the series of input forms via a next button 412.

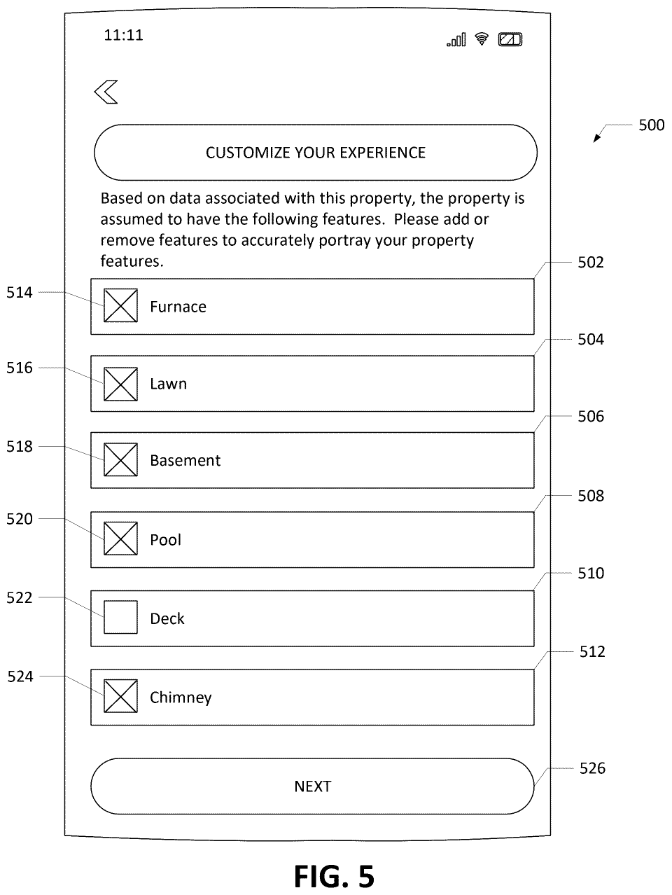

As shown in FIG. 5, the user interface 102 may present a fourth form 500 (e.g., based on user selection of the next button 412 from the third form 400 of FIG. 4) requesting information such as, for example, confirmation of features of a user's property. The features of the user's property may include, for example, furnace, boiler, radiator, lawn, driveway, basement, multiple floors, number of bathrooms, number of bedrooms, open or closed floor plan, pool, deck, chimney, solar panels, back-up generator, something else, etc. In some examples, the fourth form 500 may include a number of options 502, 504, 506, 508, 510, 512 that may be selected (e.g., with an “X”, a checkmark, a filled shape, etc.) via shapes 514. 516, 518, 520, 522, 524.

In some examples, based on the information acquired from the first form 200, the second form 300, the third form 400, data from the user database 104, and/or data acquired from third-party sources, the recommendation engine 106 may prepopulate the fourth form 500 with selections (e.g., X's) that match known features of a user's property (and likewise actively not select features not known to be features of the user's property or known to not be features of the user's property). For example, based on a public property listing associated with the address entered by the user in the third form 400 (e.g., a listing on Zillow®), the recommendation engine 106 may determine that the user's property has a furnace, a lawn, a basement, a pool, a chimney, and does not have a deck. Other known features or known lack of features may be determined by the recommendation engine 106 based on available data and/or data accessed via third party APIs, and used to prepopulate the fourth form 500. Thereafter, a user may merely confirm the prepopulated selections or revise them as necessary (e.g., in case the public information is inaccurate or outdated). In some examples, the fourth form 500 may include an empty text input field for a user to manually enter information, such as, for example text describing the features of the user's property. Based on the data confirmed, selected/deselected, or entered by a user, the fourth form 500 may enable the user interface 102 to acquire/update such data and store it in the user database 104 (e.g., a part of a user profile). In some examples, a user may proceed through the series of input forms via a next button 526.

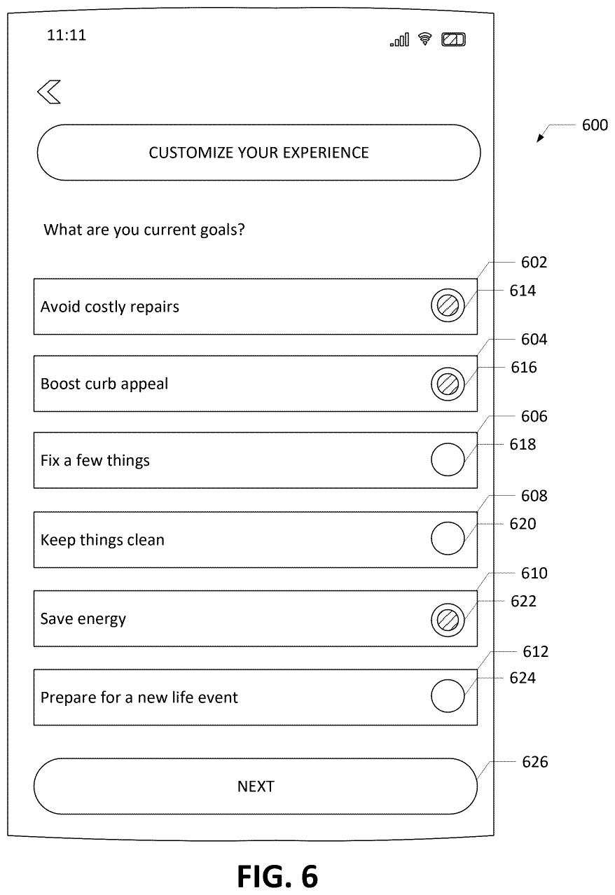

As shown in FIG. 6, the user interface 102 may present a fifth form 600 (e.g., based on user selection of the next button 526 from the fourth form 500 of FIG. 5) requesting information such as, for example, a user's current goals relating to themselves or their property. The user's goals may include, for example, avoiding costly repairs, boosting curb appeal, fixing a few things around the property, keeping the property clean, saving energy, preparing for a new life event (e.g., moving, babyproofing, renovations), something else, etc. In some examples, the fifth form 600 may include a number of options 602, 604, 606, 608, 610, 612 that may be selected (e.g., with an “X”, a checkmark, a filled shape, etc.) via shapes 614, 616, 618, 620, 622, 624. In some examples, the fifth form 600 may include an empty text input field for a user to manually enter information, such as, for example text describing the user's goals. Based on the data selected or entered by a user, the fifth form 600 may enable the user interface 102 to acquire such data and store it in the user database 104 (e.g., a part of a user profile). In some examples, a user may proceed through the series of input forms via a next button 626.

In some examples, the user interface 102 may present one or more additional data input forms instead of, or in addition to, the first form 200, the second form 300, the third form 400, the fourth form 500, and the fifth form 600. For example, additional forms enabling the user to select (e.g., “−” or “+”) a number of bathrooms, bedrooms, garage bays, floors, etc. may be presented via the user interface 102. As another example, additional forms enabling the user to select details about their outdoor space (e.g., whether the user has grass, large trees, a deck, a pool, etc.). In some examples, the first form 200, the second form 300, the third form 400, the fourth form 500, the fifth form 600, and any additional forms may be presented sequentially as described herein. In some examples, the first form 200, the second form 300, the third form 400, the fourth form 500, the fifth form 600, and any additional forms may be presented in any order.

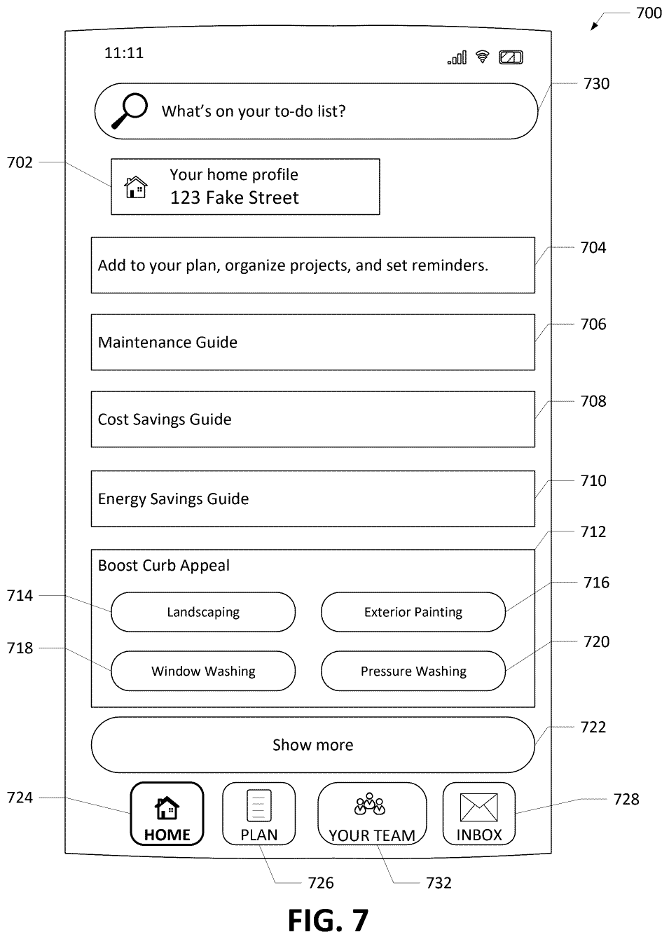

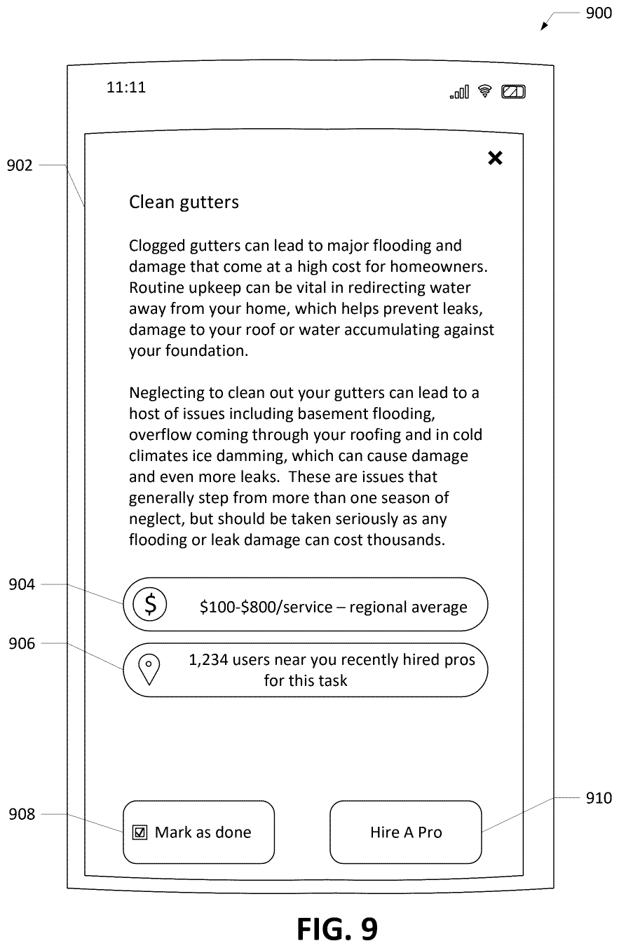

Based on the data in the user database 104, the user interface 102 may present to a user a user profile home page 700, as shown in FIG. 7. The home page 700 may visually present aspects of the information entered by the user via the first form 200, the second form 300, the third form 400, the fourth form 500, and the fifth form 600 and/or information gathered by the recommendation engine 106 via the network 112 (e.g., from one or more third-party APIs). For example, the home page 700 may identify in a field 702 the property associated with the user profile via the address (e.g., 123 Fake Street) of the property entered by the user via the third form 400. The home page 700 may further present one of more interactive fields including a field 704 for adding tasks to a plan, organizing tasks, and setting reminders, a field 706 for a maintenance guide (which the user interface 102 may present based on a user selection of the shape 614 from the fifth form 600), a field 708 for a cost savings guide (which the user interface 102 may additionally or alternatively present based on a user selection of the shape 614 from the fifth form 600), a field 710 for an energy savings guide (which the user interface 102 may present based on a user selection of the shape 622 from the fifth form 600), and a field 712 for boosting curb appeal (which the user interface 102 may present based on a user selection of the shape 616 from the fifth form 600). In some examples, the fields 704, 706, 708, 710, 712 may include one or more sub-fields 714, 716, 718, 720 relating to a corresponding field. For example, the field 712 may have a sub-field 714 for landscaping, a sub-field 716 for exterior painting, a sub-field 718 for window washing, and a sub-field 720 for pressure washing. Upon user-selection of the field 706, the field 708, the field 710, the field 712, the sub-field 714, the sub-field 716, the sub-field 718, or the sub-field 720, the user interface 102 may present a corresponding guide (as further described below with respect to FIG. 9).

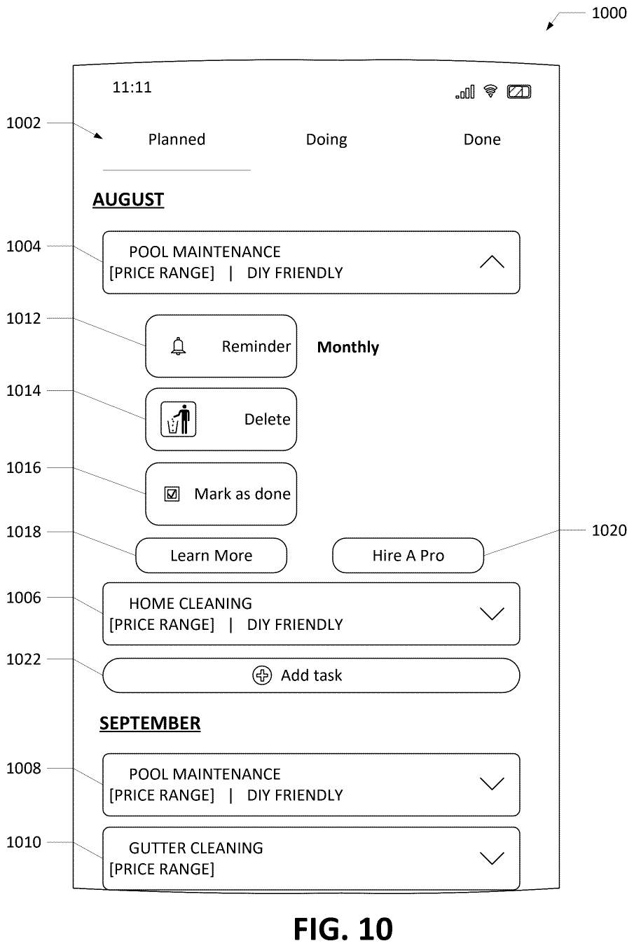

One or more additional fields may be populated by user selection of a show more option 722. The home page 700 may further have navigation options, including a home navigation option 724, a plan navigation option 726, and an inbox navigation option 728. In some examples, the home navigation option 724 may enable navigation to the home page 700. In some examples, the plan navigation option 726 may enable navigation to the user's plan (as further described below with respect to FIG. 10). In some examples, the inbox navigation option 728 may enable navigation to a messaging system in which users may interact amongst themselves and/or with professionals to be hired, already hired, or previously hired to perform a task. In some examples, the messaging system may be organized by task, by pros, by date, by whether a task has been quoted/bid by a pro, etc.

In some examples, the home page 700 may further include a search query 730 for a user to query various options provided by the task management system 100 (e.g., search for any and all tasks and/or guides within the task list database 108, the guidance database 110, and/or the network 112). For example, although certain tasks and guides may be recommended to a user, a user can locate non-recommended tasks and guides via the search query 730. In some examples, a user may be able to filter tasks from the task list database 108 and/or filter guides from the guidance database 110 according to topic, DIY friendly, high return on investment, etc. in order to locate tasks and/or guides of interest. In some examples, data entered into the search query 730 may be saved and associated with the user's profile. In some examples, such stored data may be used to prepopulate the search query 730 to streamline identifications of options that users may frequently search for with the search query 730.

In some examples, the search query 730 may enable a user to create custom tasks that may or may not literally match to the task(s) within the task list database 108. For example, a user may search for installation of a home level 2 electric charger. In some such examples, the search query 730 may determine the context of the search request and locate potentially relevant tasks within the task list database 108 that contextually relate to the search request. For example, the search query 730 may return tasks such as “switch and outlet installation,” “wiring installation,” “electrical and wiring repair,” and/or “circuit breaker panel or fuse box installation,” in response to the “home level 2 electric charger” search request.

In some examples, a your team option 732 may allow users to save, message, view specialties of, view history of, view availability of, book, rebook, pay, and/or share professionals. In some examples, the your team option 732 may enable users to manage professionals (via a single user interface or tab) that have previously provided satisfactory results with respect to performing specified tasks. For example, the your team option 732 may provide (to a user) contact information (e.g., that may have been misplaced) for a professional that previously performed the gutter cleaning task 814 (e.g., last year) so that the user may easily hire the same professional again. Likewise, the your team option 732 may enable users to message, rebook, and share information associated with the professional (e.g., that previously performed the gutter cleaning task 814) with additional users.

In some examples, the home page 700 may provide an indication that the user profile is incomplete or (potentially) outdated and requires additional information from the user. In some examples, a user may complete or update their user profile through one or more additional data input forms or connections/links to additional user accounts. In some examples, the home page 700 may provide such an indication periodically to ensure the task management system 100 has the most up-to-date information about a user and/or their property.

In some examples, user interaction with the field 704 for adding tasks to a plan, organizing tasks, and setting reminders on the home page 700 may cause the user interface 102 to present a task page 800. The task page 800 may comprise one or more tasks selected by the recommendation engine 106 based on one or more aspects of the user profile from the user database 104 matching aspects of one or more tasks in the task list database 108. For example, if the user selected shape 520 associated with option 508 from the fourth form 500 corresponding to “pool,” or the recommendation engine 106 communicated over the network 112 with a third-party API based on a user-input address (e.g., from the field 402 from the third form 400) and determines that the user's property has a pool, the recommendation engine 106 may search for tasks in the task list database 108 associated with pools. If the recommendation engine 106 locates one or more tasks matching the pool feature of the user profile, the recommendation engine 106 may cause the user interface 102 to present such tasks to the user via the task page 800. For example, the user interface 102 may present a pool maintenance task 802. In some examples, the user interface 102 may present the pool maintenance task 802 with a price range 804 associated with such a task (which may be stored in the task list database 108), an indicator 806 as to whether such a task is do-it-yourself (DIY) friendly (which may be stored in the task list database 108), a learn more option 808, an add-to-plan option 810, and a hire-a-pro option 812.

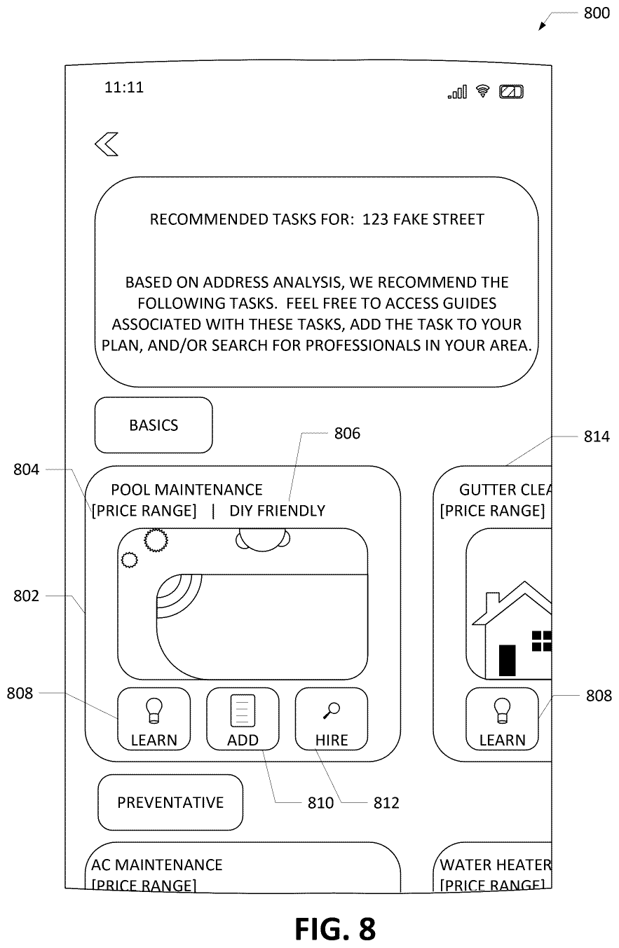

As another example, if the user selected shape 620 associated with option 608 from the fifth form 600 corresponding to “Keep things clean,” the recommendation engine 106 may search for tasks in the task list database 108 associated with cleaning. If the recommendation engine 106 locates one or more tasks matching cleaning, the recommendation engine 106 may cause the user interface 102 to present such tasks to the user via the task page 800. For example, the user interface 102 may present a gutter cleaning task 814. In some examples, the user interface 102 may present the gutter cleaning task 814 with similar interactive components as described with respect to the pool maintenance task 802 (e.g., a price range, an indicator as to whether such a task is do-it-yourself (DIY) friendly, a learn more option, an add-to-plan option, and a hire-a-pro option, although as shown in FIG. 8, one or more interactive components may appear outside the boundaries of the task page 800 and may require the user to navigate (e.g., by swiping with their finger, moving a input device, clicking an arrow, etc.) the task page 800 and make such interactive components visible.

Additional tasks may be recommended by the recommendation engine 106 based on whether aspects of the user profile match with aspects of one or more tasks within the task list database 108. For example, a user having an apartment may be matched with tasks such as home cleaning, checking smoke alarms, replacing lightbulbs, or HVAC filter replacement, as a majority of other tasks may be handled by landlords, home-owner associations, or building management. In contrast, a user having a single-family home with a pool and a large lot with a plurality of mature trees may be matched with landscaping, fertilization, weed prevention and/or removal, aeration, over-seeding, lawn mowing, leaf blowing and removal, tree trimming, bush trimming, spring/fall cleanup, flower bed clean up, mulch installation, snow removal, gutter cleaning, gutter guard installations, lawn sprinkler installation, spring start-up, and winter valve removal, pool opening, closing, and maintenance, checking smoke alarms, replacing lightbulbs, HVAC maintenance and/or repairs, HVAC filter replacement, water heater maintenance and/or repairs, water softener salt delivery, appliance maintenance, repairs, and/or upgrades, repairing grout, painting, home cleaning, window washing, roof repair, floor replacement, home inspections, pest prevention, control, and/or removal, plumbing repair, septic maintenance, sump-pump replacement, electrical repair, wall repair, trim installations, window installations, etc.

In some examples, each recommended task may be associated with a learn more option 808, an add-to-plan option 810, and a hire-a-pro option 812. The learn more option 808 may enable a user to navigate to one or more guides associated with that particular task. For example, the pool maintenance task 802 may be associated with one or more guides for cleaning a pool, changing a pool filter, adding the correct chemicals and correct proportions of those chemicals, etc. In some examples, the one or more guides may comprise step-by-step instructions for walking a non-professional through the necessary subtasks for completing the primary task. In some examples, such step-by-step instructions may be associated with only DIY friendly tasks (such as pool maintenance). In some examples, the step-by-step instructions may be textual, pictorial, and/or videographic.

As another example, the gutter cleaning task 814 may be associated with one or more guides for cleaning gutters. For example, as shown in FIG. 9, the user interface 102 may present a guide page 900 to a user (e.g., based on user selection of the learn more option 808 associated with the gutter cleaning task 814 illustrated in FIG. 8). The guide page 900 may comprise a guide 902, which may contextually describe the gutter cleaning task 814. In some examples, the guide page 900 may comprise content that is personalized to a user based on details from the user's profile in the profile database. For example, the recommendation engine 106 may determine that the user has a single-family home and thus may recommend the guide 902 for cleaning gutters. However, the recommendation engine 106 may determine to not recommend the guide 902 for cleaning gutters to another user because that user has an apartment. In some examples, the recommendation engine 106 may determine one or more guides that may align with user-specified goals (e.g., saving energy, renovations, baby-proofing a home, etc.). In some examples, the guide and/or the importance of investing in completing the underlying task associated with the guide. For example, the guide 902 may include general information regarding potential harmful side effects resulting from not performing the gutter cleaning task 814.

In some examples, the guide 902 may comprise a price range 904 associated with the gutter cleaning task 814 and a location-based identification 906 of a number of other local users that have hired professionals (“pros”) for the gutter cleaning task 814. In some examples, the user interface 102 may present additional guides—such as a series of steps to perform the gutter cleaning task 814 by the user themselves, or to serve as a mechanism enabling informative supervision of a hired pro. In some examples, the series of steps may be textual, pictorial, and/or videographic. In some examples, the guide 902 may comprise an option 908 for indicating that the user performed or had a hired pro perform the gutter cleaning task 814. In some examples, the guide 902 may comprise a hire-a-pro option 910 in launch a user-professional matching platform for connecting users to qualified professionals providing services associated with the particular task (e.g., gutter cleaning). In some examples, the user-professional matching platform and the task management system 100 described herein may be integrated together. In some examples, the recommendation engine 106 may share aspects (or the entirety) of the user's profile with a professional via the user-professional matching platform.

Turning back to FIG. 8, a user may not be interested in learning about a particular task or may have tried to learn about a particular task and found it to be over their head. In some examples, the user may select the hire-a-pro option 812. The hire-a-pro option 812 may link to the same platform as described above with respect to the hire-a-pro option 910.

In some examples, a user may be interested in performing or hiring a professional to perform a particular task, but not at the present time. In some examples, a user may select the add-to-plan option 810. The add-to-plan option 810 may enable a user to save or otherwise add a particular task to a temporal based structure in which the user may associate a particular task at a particular frequency of occurrence. Thus, a user may be able to set up (recurring) tasks to keep track of tasks throughout the time spent at or during ownership of the user's property. In some examples, upon selection of the add-to-plan option 810, the user interface 102 may present an indicator (e.g., a checkmark) to inform the user that the task has been saved or otherwise added to their plan. In some examples, if a user selects the add-to-plan option 810 again, the particular task may be removed from their plan. In some such examples, any previously presented indictor may be removed to inform the user that the task has been removed from their plan.

As shown in FIG. 10, the user interface 102 may present a user's plan 1000 (e.g., based on selection of the plan navigation option 726 from FIG. 7 or selection of the add-to-plan option 810 from FIG. 8) to the user. In the illustrated example of FIG. 10, the user interface 102 may present the user's plan 1000 in a list format. In some examples, the user interface 102 may present the user's plan 1000 in a calendar format. In some examples, the user interface 102 may present the user's plan 1000 in a combined list-calendar format. As shown in FIG. 10, the user's plan 1000 may comprise a number of tabs, including a “planned” tab 1002. In some examples, the “planned” tab 1002 may comprise a listing of each task saved or otherwise added to a user's plan. In some examples, the listing of each task may be separated by month. For example, the listing of each task may identify a first task 1004 (e.g., pool maintenance) and a second task 1006 (e.g., home cleaning) associated with a first month (e.g., August); and a third task 1008 (e.g., pool maintenance) and a fourth task 1010 (e.g., gutter cleaning) associated with a second month (e.g., September). In some examples, the listing of each task may be organized differently such as by another time frame (e.g., by hour, by day, by week, by season, by year), by task type (e.g., exterior, interior, cleaning, repair, replacement, installation, etc.), by priority (e.g., repairs or replacements being ranked with higher priority than cleaning or basic maintenance), or by user selection.

Each task may be condensed (as illustrated with the second task 1006, the third task 1008, and the fourth task 1010) or expanded (as illustrated with the first task 1004). For example, the first task 1004 may be expanded to reveal various plan related options such as, for example, a reminder option 1012, a delete option 1014, a mark as done option 1016, a learn more option 1018, and/or a hire-a-pro option 1020.

The reminder option 1012 may enable the user to create custom reminders associated with occurrences of a particular task, so as to be made continually aware of upcoming maintenance, required tasks, or selected tasks. In some examples, the reminders may be set up to reoccur every week, biweekly, every three weeks, monthly, every three months, every six months, annually, just once, or according to a user-defined custom schedule. In some examples, the reminders may be set up to a default reminder schedule in accordance with an anticipated frequency associated with a particular task. For example, the recommendation engine 106 may determine an interval associated with a task based on data within the task list database 108. In some examples, the recommendation engine 106 may determine an interval associated with a task based on data within the user profile from the user database 104. For example, some tasks may be performed seasonally (e.g., fall clean up) and the recommendation engine 106 may select a default reminder schedule in accordance with the corresponding season. In some examples, the recommendation engine 106 may select a default reminder schedule based on data from the task list database (e.g., recommending house cleaning as bi-weekly based on aggregate data of users previously completing house cleaning tasks every two weeks on average). In some examples, the recommendation engine 106 may select a default reminder schedule based on data from the user profile (e.g., recommending house cleaning as weekly based on the user previously completing house cleaning tasks weekly). In some examples, the reminders created via the reminder option 1012 may be integrated into a user's existing scheduling software, such as for example a digital calendar.

In some examples, the user interface 102 may enable a user to create sub-reminders associated with a particular task. For example, some tasks may have multiple steps that will be performed over time. Accordingly, a user may set up reminders for each step associated with a particular task. In some examples, the user interface 102 may enable a user to create additional reminders for other aspects of a task such as for gathering materials for a task, cleaning an area where the task is going to be performed, hiring additional pros to prepare the area for the task, etc.

In some examples, the recommendation engine 106 may determine the interval based on climate data associated with a user's profile. For example, the recommendation engine 106 may recommend pool cleaning more frequently to users in a warmer climate than users in a colder climate. In some examples, tasks may be not recommended at all based on climate and/or location. For example, the recommendation engine 106 may not recommend pool cleaning in Alaska. As another example, the recommendation engine 106 may not recommend pool cleaning during the height of winter in Chicago. Additionally, recommended tasks may be prioritized based on climate and/or location. For example, tasks relating to snow/ice removal may be prioritized during the height of winter in Chicago. In some examples, the recommendation engine 106 may, via a weather-based API, prioritize snow removal based on data indicating that a winter storm is imminent or on-going.

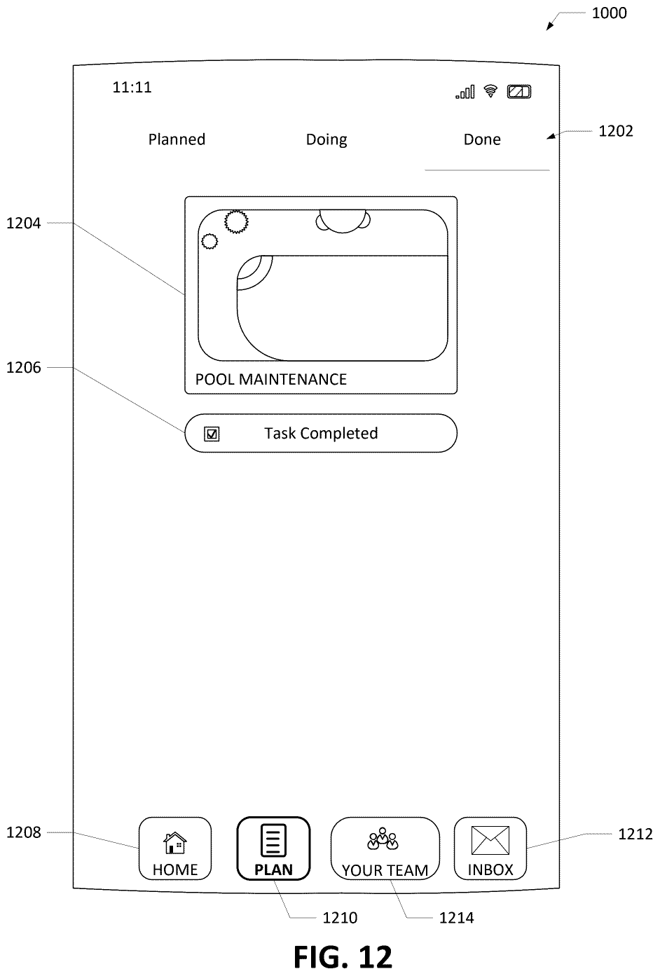

The delete option 1014 may enable the user to remove the task from the user's plan. This may be due to conflict, lack of interest, or other reasons. The user may alternatively use the mark as done option 1016 to remove the task from the user's plan. As further described below, selecting the mark as done option 1016 may cause the additional step of adding the task to a done tab (as described with respect to FIG. 12), whereas the delete option 1014 may not. Additionally, the learn more option 1018 may operate similarly to the learn more option 808 described with reference to FIG. 8. Also, the hire-a-pro option 1020 may operate similarly to the hire-a-pro option 812 described with reference to FIG. 8 or the hire-a-pro option 910 described with reference to FIG. 9. In some examples, the “planned” tab 1002 may further comprise an add task button 1022 to save or otherwise add additional tasks directly from the “planned” tab 1002, as described herein.

In some examples, upon user-selection of a task within the “planned” tab 1002, the user interface 102 may present a task details page. In some examples, the task details page may comprise high level details about a particular task (e.g., less content than the guide(s) associated with the particular task), task steps with respective timelines, progress relating to hiring a pro, existing reminders, and/or user-created notes. In some examples, the components of the task details page may be editable by a user. For example, the user may be able to set or revise deadlines to change the timelines associated with a particular task, adjust or set additional reminders, add subtasks, upload documents, pictures, videos, and other content, and add, edit, or delete the user-created notes.

In some examples, upon activation of the “planned” tab 1002, the user interface 102 may present a project process and goal tracking page. In some examples, the project process and goal tracking page may present a dashboard view associated with a user plan. The dashboard view may enable project progress tracking and updates with respect to projects and goals completed over a specified time period (e.g., a year). If progress has been made with respect to implementing the user plan, then insights associated with the progress (e.g., money saved by doing preventive maintenance, value added to a home, etc.) may be presented or transmitted to a user.

In some examples, a user may be issued a reward (e.g., a score or points) for performing or completing specified projects and tasks (e.g., with respect to home improvement tasks). The reward may be issued to implement game like elements for encouraging a user to utilize an interactive task management platform (e.g., task management system 100 of FIG. 1) for future projects or tasks. For example, a user may be awarded 25 points for completing a pool cleaning project and 45 points for completing a gutter cleaning project. These points may be applied to place the user at a specified level. Subsequently, if the user completes additional projects via the interactive task management platform, the user may be issued additional points that may place the user at a higher level which may provide user discounts with respect to purchase of materials or hiring professionals for completing future projects.

In some examples, upon activation of the “planned” tab 1002, the user interface 102 may present a page configured to enable additional users to be added to collaborate on projects. In some examples, this page may present a dashboard view enabling users of, for example, a same household (e.g., added to the project via this page) to collaborate with respect to a same plan for their home to complete projects such that they may collaboratively manage projects of their plan (e.g., add, remove, delete, mark as done, etc.), set and receive reminders, add notes, etc. Likewise, users may be enabled to search and review professionals collaboratively prior to making a hiring decision, message and talk to professionals together, etc.

In some examples, upon activation of the “planned” tab 1002, the user interface 102 may present a planning page. In some examples, the planning page may present a dashboard view enabling users to upload an inspection report and/or photographs or video (e.g., of a home or property) to be added to a plan. Subsequently, recommendations associated with prioritizing projects may be generated and presented based on the uploads.

In some examples, upon activation of the “planned” tab 1002, the user interface 102 may present a planning page. In some examples, the planning page may present a dashboard view enabling input of details with respect to any project of a plan and in response, an estimated pricing range may be instantaneously presented. Likewise, top rated professionals and associated quotes to complete a project may be presented via the planning page.

In some examples, upon activation of the “planned” tab 1002, the user interface 102 may present a due date page. In some examples, the due date page may present a dashboard view associated with inputting a project due date with respect to a project of a plan and in response, reminders (e.g., push notifications, email, etc.) may be created with respect for a user.

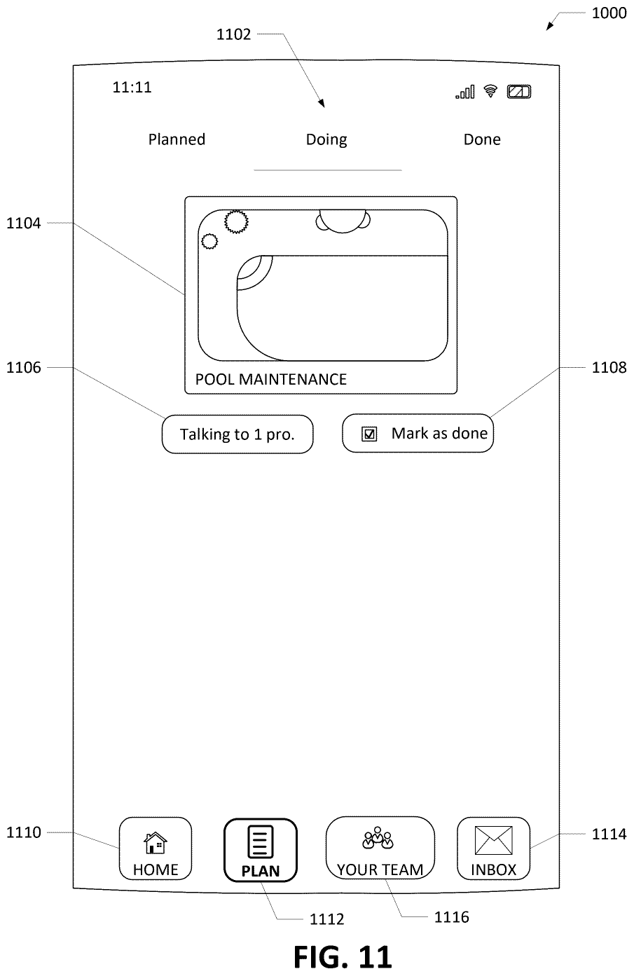

In some examples, upon user-selection of the hire-a-pro option 812 described with reference to FIG. 8, the hire-a-pro option 910 described with reference to FIG. 9, or the hire-a-pro option 1020 described with reference to FIG. 10, the user interface 102 may present the corresponding task associated with the respective hire-a-pro option within a “doing” tab 1102 shown in FIG. 11. For example, as illustrated in FIG. 11, a user may have decided to hire a pro for a pool maintenance task 1104 and the user interface 102 may present the pool maintenance task 1104 under the “doing” tab 1102. In some examples, the user interface 102 may comprise a status indicator 1106, which may indicate the status of an ongoing task. For example, the status indicator 1106 may indicate that a user has began talking with a single pro. In some examples, the status indicator 1106 may indicate that a user has gotten bids from multiple pros. In some examples, the status indicator 1106 may indicate that a user has accepted a bid from a pro. In some examples, the status indicator 1106 may indicate that a user has declined all bids from pros. In some examples, the status indicator 1106 may indicate that a pro has began work on the task. In some examples, the status indicator 1106 may indicate that a pro has finished work on the task. In some examples, the user interface 102 may comprise a mark as done option 1108 similar to the mark as done option 1016 as described with respect to FIG. 10.

In some examples, the user interface 102 may comprise a home navigation option 1110, a plan navigation option 1112, an inbox navigation option 1114, and a your team option 1116. In some examples, the home navigation option 1110, the plan navigation option 1112, the inbox navigation option 1114, and the your team option 1116 may be similar to the home navigation option 724, the plan navigation option 726, the inbox navigation option 728, and the your team option 732 as described with respect to FIG. 7. In some examples, the plan navigation option 1112 may be emphasized (e.g., bold, colored, highlighted, etc.) to indicate that the user is being presented the user's plan 1000.

In some examples, upon user-selection of the mark as done option 1016 described with reference to FIG. 10, upon user-selection of the mark as done option 1108 described with reference to FIG. 11, or upon receipt of an indication, from a pro, that a task is complete, the user interface 102 may present the corresponding completed task within a “done” tab 1202 shown in FIG. 12. For example, as illustrated in FIG. 12, a user or a hired professional may have completed a pool maintenance task 1204 and the user interface 102 may present the pool maintenance task 1204 under the “done” tab 1202. In some examples, the user interface 102 may comprise a status indicator 1206, which may indicate that the task has been completed. In some examples, the user interface 102 may present additional information such as date of completion, one or more photos or videos evidencing completion of the task, whether the task was completed by the user or a hired profession, and if a hired professional completed the task, which professional completed the task. In some examples, the user interface 102 may enable the user to interact with the pool maintenance task 1204 to create, save, or otherwise add a subsequent occurrence of that task to the user's plan 1000. In some examples, the user interface 102 may comprise a home navigation option 1208, a plan navigation option 1210, an inbox navigation option 1212, and a your team option 1214 which may be respectively similar to the home navigation option 724, the plan navigation option 726, the inbox navigation option 728, and the your team option 732 as described with respect to FIG. 7; or the home navigation option 1110, the plan navigation option 1112, the inbox navigation option 1114, and the your team option 1116 as described with respect to FIG. 11. In some examples, the plan navigation option 1210 may be emphasized (e.g., bold, colored, highlighted, etc.) to indicate that the user is being presented the user's plan 1000.

In some examples, the recommendation engine 106 may be able to determine that a user completed a task on their own. For example, the recommendation engine 106 may collect data associated with user activity relating to the task management platform 100 such as, for example, a user selecting a DIY friendly task, a user viewing one or more guides associated with the DIY friendly task, a user adding the task to their plan, a user declining all bids from pros, and/or a user marking the task as being completed without the user interacting with the hire-a-pro option. Based on one or more data points described above, the recommendation engine 106 may conclude that a task was performed by the user. In some examples, the recommendation engine 106 may store such a conclusion in connection with that user's profile, and use that data in future recommendations. For example, the recommendation engine 106 may use previously identified completed DIY tasks as a basis to recommend more DIY tasks. In some examples, the recommendation engine 106 may use previously identified completed DIY tasks as a basis to recommend more DIY guides. In some examples, the recommendation engine 106 may use previously identified completed DIY tasks as a basis to not recommend non-DIY tasks or guides.

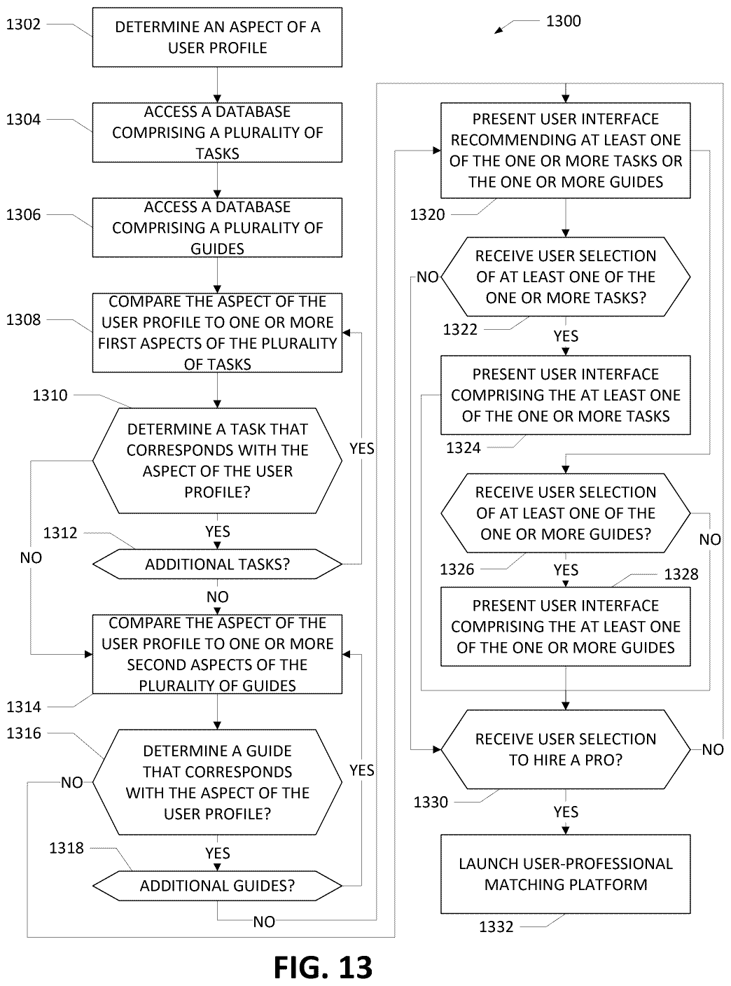

FIG. 13 is a flowchart representative of a method 1300 for recommending tasks and guides as described herein. In some examples, the recommendation engine 106 and/or the user interface 102 may perform the method 1300. At block 1302, the recommendation engine 106 may determine an aspect of a user profile. In some examples, the recommendation engine 106 may access the user database 104 to locate a user profile associated with a particular user. At block 1304, the recommendation engine 106 may access a database comprising a plurality of tasks (e.g., the task list database 108). At block 1306, the recommendation engine 106 may access a database comprising a plurality of guides (e.g., the guidance database 110). At block 1308, the recommendation engine 106 may compare the aspect of the user profile to one or more aspects associated with each task of the plurality of tasks. If the recommendation engine 106 determines a task that corresponds with the aspect of the user profile (block 1310: YES), the recommendation engine 106 may log that task and determine whether there are additional tasks to search. If there are additional tasks (block 1312: YES), then control returns to block 1308. If the recommendation engine 106 determines there are no tasks that correspond with the aspect of the user profile (block 1310: NO) or if the recommendation engine 106 has no additional tasks to search (block 1312: NO), then control proceeds to block 1314. At block 1314, the recommendation engine 106 may compare the aspect of the user profile to one or more aspects associated with each guide of the plurality of guides. If the recommendation engine 106 determines a guide that corresponds with the aspect of the user profile (block 1316: YES), the recommendation engine 106 may log that guide and determine whether there are additional guides to search. If there are additional guides (block 1318: YES), then control returns to block 1314. If the recommendation engine 106 determines there are no guides that correspond with the aspect of the user profile (block 1316: NO) or if the recommendation engine 106 has no additional guides to search (block 1382: NO), then control proceeds to block 1320.

At block 1320, the user interface 102 may present a graphical user interface recommending at least one of the tasks and/or at least one of the guides logged by the recommendation engine 106. If the user interface 102 receives a user selection of at least one of the logged tasks (block 1322: YES), then the user interface 102 may save or otherwise add that task to a user's plan. In some examples, the user interface 102 may present a graphical user interface representing the user's plan comprising the at least one selected task. Similarly, if the user interface 102 receives a user selection of at least one of the logged guides (block 1326: YES), then in block 1328, the user interface 102 may present a graphical user interface comprising the at least one selected guide.

In some examples, the user interface 102 may include an activator for enabling a planning option associated with the plurality of tasks such that user selection may be received to enable the activator for presenting a graphical user interface presenting a plan for completing the plurality of tasks.

In some examples, the plan may be generated based on adding at least one of the plurality of tasks to a temporal based structure in which the at least one of the plurality of tasks is associated with specified frequency of occurrence.

In some examples, the plan may be presented in a list format, a calendar format, a combined list-calendar format, etc.

In some examples, sub-reminders associated with the plurality of tasks may be generated such that at least one of the plurality of tasks includes multiple steps to be performed over time.

In some examples, progress associated with implementation of the plan may be tracked for completing at least one of the plurality of tasks.

In some examples, multiple parties (e.g., family members living in a same household) may be enabled to collaborate with respect to implementation of the plan.

In some examples, data describing areas or structures associated with performing at least one of the plurality of tasks may be received and added to the plan. In some examples, the data may include an inspection report describing a structure or property associated with at least one of the plurality of tasks. In some examples, the data may include a photograph, a video, an augmented reality structure, or a 3D reconstruction describing a structure or property associated with at least one of the plurality of tasks.

In some examples, indicators associated with a projected timeframe for completion of the plan may be generated and provided to a user implementing the plan.

In some examples, a reward may be applied to a user for completing at least one of the plurality of tasks.

If the user interface 102 does not receive a user selection of at least one of the logged tasks (block 1322: NO), if the user interface 102 does not receive a user selection of at least one of the logged guides (block 1326: NO), after the user interface 102 presents the graphical user interface representing the user's plan comprising the at least one selected task, or after the user interface 102 presents the graphical user interface comprising the at least one selected guide, the user interface 102 may await user selection of a hire-a-pro option in block 1330. If the user interface 102 does not receive a user selection to hire a pro (block 1330: NO), control may return to block 1320. If the user interface 102 does receive a user selection to hire a pro (block 1330: YES), then the task management platform 100 may launch a user-professional matching platform for connecting users with entities (e.g., professionals) providing services associated with the at least one selected task in block 1332.

In some examples, the aspect of the user profile is shared with the entities. In some examples, the user-professional matching platform may enable communications between a user and at least one of the entities. In some examples, the user interface 102 may present a graphical user interface representing presentation of a group of entities that have performed prior tasks for a user and contact information for each entity of the group of entities.

In some examples, the method 1300 may be a continuous loop. In some examples, the method 1300 may be performed multiple times. In some examples, the method 1300 may include further features as described herein.

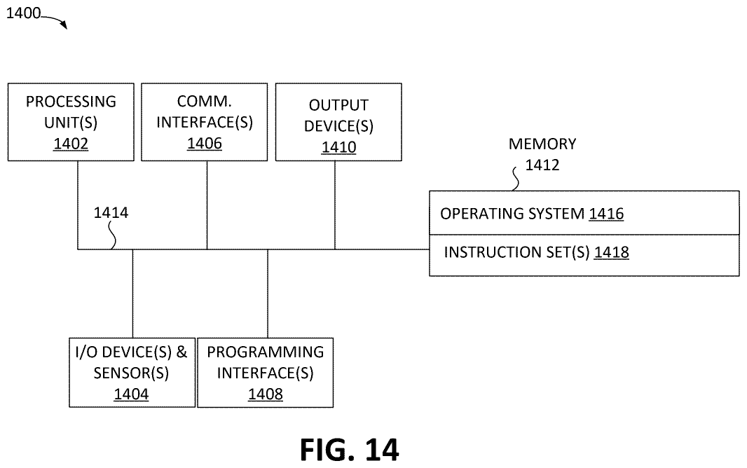

FIG. 14 is a block diagram of electronic device 1400. Device 1400 illustrates an exemplary device configuration for the user interface 102, the recommendation engine 106, and/or more generally, the task management system 100. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1400 includes one or more processing units 1402 (e.g., microprocessors, ASICs, FPGAs, GPUs, CPUs, processing cores, and/or the like), one or more input/output (I/O) devices and sensors 1404, one or more communication interfaces 1406 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1408, one or more output device(s) 1410, a memory 1412, and one or more communication buses 1414 for interconnecting these and various other components.

In some implementations, the one or more communication buses 1414 include circuitry that interconnects and controls communications between system components. In some implementations, the one or more I/O devices and sensors 1404 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1410 include one or more displays. In some implementations, the one or more output device(s) 1410 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more output device(s) 1410 correspond to diffractive, reflective, polarized, holographic, etc. waveguide displays. In one example, the device 1400 includes a single display.

In some implementations, the one or more output device(s) 1410 include one or more audio producing devices. In some implementations, the one or more output device(s) 1410 include one or more speakers. The one or more output device(s) 1410 may additionally or alternatively be configured to generate haptics.

The memory 1412 includes high-speed random-access memory, such as DRAM, SRAM, DDR RAM, or other random-access solid-state memory devices. In some implementations, the memory 1412 includes non-volatile memory, such as one or more magnetic disk storage devices, optical disk storage devices, flash memory devices, or other non-volatile solid-state storage devices. The memory 1412 optionally includes one or more storage devices remotely located from the one or more processing units 1402. The memory 1412 comprises a non-transitory computer readable storage medium.

In some implementations, the memory 1412 or the non-transitory computer readable storage medium of the memory 1412 stores an optional operating system 1416 and one or more instruction set(s) 1418. The operating system 1416 includes procedures for handling various basic system services and for performing hardware dependent tasks. In some implementations, the instruction set(s) 1418 include executable software defined by binary information stored in the form of electrical charge. In some implementations, the instruction set(s) 1418 are software that is executable by the one or more processing units 1402 to carry out one or more of the techniques described herein. The instruction set(s) 1418 may be configured to, upon execution, generate the various graphical user interfaces, match aspects of user profiles to aspects of tasks and guides and provide recommendations based on the matching, and/or more generally, manage tasks and guides within the platforms as described herein, whether in a single device or within respective devices in a single system.

Although the instruction set(s) 1418 are shown as residing on a single device, it should be understood that in other implementations, any combination of the elements may be located in separate computing devices. Moreover, FIG. 14 is intended more as a functional description of the various features which are present in a particular implementation as opposed to a structural schematic of the implementations described herein. As recognized by those of ordinary skill in the art, items shown separately could be combined and some items could be separated. The actual number of instruction sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied; for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modifications may be implemented by those skilled in the art without departing from the scope and spirit of the invention.

What is claimed is:

1. A method comprising:
determining an aspect of a user profile;
accessing a first database comprising a plurality of tasks;
accessing a second database comprising a plurality of guides;
comparing the aspect of the user profile to one or more first aspects of the plurality of tasks;
determining, based on the comparing the aspect of the user profile to one or more first aspects of the plurality of tasks, one or more tasks of the plurality of tasks that correspond with the aspect of the user profile;
comparing the aspect of the user profile to one or more second aspects of the plurality of guides;
determining, based on the comparing the aspect of the user profile to one or more second aspects of the plurality of guides, one or more guides of the plurality of guides that correspond with the aspect of the user profile;
presenting a first user interface recommending at least one of the one or more tasks or the one or more guides;
receiving user selection of at least one of the one or more tasks;
presenting a second user interface comprising the at least one of the one or more tasks;
receiving user selection of at least one of the one or more guides; and
presenting a third user interface comprising the at least one of the one or more guides.

2. The method of claim 1, wherein the third user interface comprises an activator for connecting users with entities providing services associated with the at least one of the one or more tasks, and wherein the method further comprises:
receiving user selection enabling the activator; and
based on said enabling the activator, launching a matching platform associated with the entities.

3. The method of claim 2, wherein the aspect of the user profile is shared with the entities.

4. The method of claim 2, further comprising:
enabling, via the matching platform, communications between a user and at least one of the entities.

5. The method of claim 2, further comprising:
presenting a fourth user interface enabling presentation of a group of entities of the entities that have performed prior tasks and contact information for each entity of the group of entities.

6. The method of claim 1, wherein the third user interface comprises an activator for enabling a planning option associated with the at least one of the one or more tasks, and wherein the method further comprises:
receiving user selection enabling the activator; and
based on said enabling the activator, presenting a fourth user interface presenting a plan for completing the at least one of the one or more tasks.

7. The method of claim 6, wherein the plan is generated based on adding the at least one of the one or more tasks to a temporal based structure in which the at least one of the one or more tasks is associated with specified frequency of occurrence.

8. The method of claim 6, wherein the plan is presented in a format selected from the group consisting of a list format, a calendar format, and a combined list-calendar format.

9. The method of claim 6, further comprising:
based on user input, creating sub-reminders associated with the at least one of the one or more tasks such that the at least one of the one or more tasks includes multiple steps to be performed over time.

10. The method of claim 6, further comprising:
tracking progress associated with implementation of the plan for completing the at least one of the one or more tasks.

11. The method of claim 6, further comprising:
enabling, via the fourth interface, multiple parties to collaborate with respect to implementation of the plan.

12. The method of claim 6, further comprising:
receiving data describing areas or structures associated with performing the at least one of the one or more tasks; and
adding the data to the plan.

13. The method of claim 12, wherein the data comprises an inspection report describing a structure or property associated with the at least one of the one or more tasks.

14. The method of claim 12, wherein the data comprises a photograph, a video, an augmented reality structure, or a 3D reconstruction describing a structure or property associated with the at least one of the one or more tasks.

15. The method of claim 6, further comprising:
generating indicators associated with a projected timeframe for completion of the plan; and
providing the indicators to a user implementing the plan.

16. The method of claim 6, further comprising:
applying a reward to a user for completing the at least one of the one or more tasks.

17. A system comprising:
one or more processors; and
memory storing program instructions that, when executed on the one or more processors, cause the system to perform operations comprising:
determining an aspect of a user profile;
accessing a first database comprising a plurality of tasks;
accessing a second database comprising a plurality of guides;
comparing the aspect of the user profile to one or more first aspects of the plurality of tasks;
determining, based on the comparing the aspect of the user profile to one or more first aspects of the plurality of tasks, one or more tasks of the plurality of tasks that correspond with the aspect of the user profile;
comparing the aspect of the user profile to one or more second aspects of the plurality of guides;
determining, based on the comparing the aspect of the user profile to one or more second aspects of the plurality of guides, one or more guides of the plurality of guides that correspond with the aspect of the user profile;
presenting a first user interface recommending at least one of the one or more tasks or the one or more guides;
receiving user selection of at least one of the one or more tasks;
presenting a second user interface comprising the at least one of the one or more tasks;
receiving user selection of at least one of the one or more guides; and
presenting a third user interface comprising the at least one of the one or more guides.

18. The system of claim 17, wherein the third user interface comprises an activator for connecting users with entities providing services associated with the at least one of the one or more tasks, and wherein the operations further comprise:
receiving user selection enabling the activator; and
based on said enabling the activator, launching a matching platform associated with the entities.

19. The system of claim 18, wherein the aspect of the user profile is shared with the entities.

20. A non-transitory computer-readable storage medium storing program instructions that, when executed, cause performance of operations comprising:
determining an aspect of a user profile;
accessing a first database comprising a plurality of tasks;
accessing a second database comprising a plurality of guides;
comparing the aspect of the user profile to one or more first aspects of the plurality of tasks;
determining, based on the comparing the aspect of the user profile to one or more first aspects of the plurality of tasks, one or more tasks of the plurality of tasks that correspond with the aspect of the user profile;
comparing the aspect of the user profile to one or more second aspects of the plurality of guides;
determining, based on the comparing the aspect of the user profile to one or more second aspects of the plurality of guides, one or more guides of the plurality of guides that correspond with the aspect of the user profile;
presenting a first user interface recommending at least one of the one or more tasks or the one or more guides;
receiving user selection of at least one of the one or more tasks;
presenting a second user interface comprising the at least one of the one or more tasks;
receiving user selection of at least one of the one or more guides; and
presenting a third user interface comprising the at least one of the one or more guides.
